(19) United States
(12) Patent Application Publication
(10) Pub. No.: US 2017/0129095 A1
(43) Pub. Date: May 11, 2017

(54) Drill Dust Collection Container System

(71) Applicant: Thomas Stanley Duncan, Sarasota, FL (US)

(72) Inventor: Thomas Stanley Duncan, Sarasota, FL (US)

(21) Appl. No.: 14/935,311

(22) Filed: Nov. 6, 2015

(51) Int. Cl. B25H 3/00; B65D 25/22

(52) U.S. Cl. CPC B25H 3/003; B65D 25/22

(57) ABSTRACT

A drill dust collection container system formed in a rectangular configuration having an open top, a lower face forming a closed bottom, a right side, a left side, a front face and a rear face. The rear face is formed with a knife edge. The container may be taped to the wall along the knife edge or held by hand, pressing the rear face of the container against the wall.

### BACKGROUND OF THE INVENTION

Field of the Invention

The present invention relates to a Drill Dust Collection Container System and more particularly pertains to a container system for positioning beneath a drilling operation and for collecting debris from the drilling operation.

Description of the Prior Art

The use of drill dust containment systems is known in the prior art. More specifically, drill dust containment systems previously devised and utilized for the purpose of capturing and containing the dust and debris resulting from using a power drill to drill a hole are known to consist basically of familiar, expected, and obvious structural configurations, notwithstanding the myriad of designs encompassed by the crowded prior art which has been developed for the fulfillment of countless objectives and requirements.

By way of example, U.S. Pat. No. 5,061,123 to Broussard a Dust Collector Adaptor for Electric Drills. U.S. Pat. No. 3,583,821 to Shaub and Bouslough discloses a Chip Catcher. Lastly, U.S. Pat. No. 8,529,170 to Everington, Jr. discloses a Retractable Drill Mounted Dust Collector.

While these devices fulfill their respective, particular objectives and requirements, the aforementioned patents do not describe Drill Dust Collection Container System that allows for positioning beneath a drilling operation and for collecting debris from the drilling operation.

In this respect, the Drill Dust Collection Container System according to the present invention substantially departs from the conventional concepts and designs of the prior art, and in doing so provides an apparatus primarily developed for the purpose of for positioning beneath a drilling operation and for collecting debris from the drilling operation.

Therefore, it can be appreciated that there exists a continuing need for a new and improved Drill Dust Collection container System which can be used for positioning beneath a drilling operation and for collecting debris from the drilling operation. In this regard, the present invention substantially fulfills this need.

### SUMMARY OF THE INVENTION

In view of the foregoing disadvantages inherent in the known types of drill dust containment systems now present in the prior art, the present invention provides an improved Drill Dust Collection Container System. As such, the general purpose of the present invention, which will be described subsequently in greater detail, is to provide a new and improved Drill Dust Collection Container System and method which has all the advantages of the prior art and none of the disadvantages.

To attain this, the present invention essentially comprises a container system formed in a rectangular configuration having an open top, a lower face forming a closed bottom, a right side, a left side, a front face and a rear face forming a bin. The top of the rear face is formed with a knife edge. The decreasing width of the knife edge limits obstruction of the debris falling into the container and allows for securing the system to a wall beneath a drilling operation with adhesive tape.

One feature of the present invention includes Serrations formed along the upper edge of the right side and the left side to improve gripping.

Another feature includes dual cutouts formed in the upper right and left corners of the front face. The container may be held by hand using the dual cutouts as finger holds and pressing the rear face of the container against the wall.

Still another feature includes serrations formed in the upper edge of the left face and in the upper edge of the right face for better gripping by a user. The serrations extend along a portion of the upper edges of the left and right faces.

An alternate embodiment of the current invention includes an optional small tab formed in one of the corners of the bin and adapted to retain a drill bit.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved Drill Dust Collection Container System which has all of the advantages of the prior art drill dust containment systems and none of the disadvantages.

It is another object of the present invention to provide a new and improved Drill Dust Collection Container System which may be easily and efficiently manufactured and marketed.

It is a further object of the present invention to provide a new and improved Drill Dust Collection Container System which is of durable and reliable constructions.

An even further object of the present invention is to provide a new and improved Drill Dust Collection Container System which is susceptible of a low cost of manufacture with regard to both materials and labor, and which accordingly is then susceptible of low prices of sale to the consuming public, thereby making such Drill Dust Collection Container System economically available to the buying public.

Another object of the present invention is to provide a system that allows for securing the system to a wall beneath a drilling operation with adhesive tape or by hand.

Lastly, it is an object of the present invention to provide a new and improved Drill Dust Collection Container System for positioning beneath a drilling operation and for collecting dust and debris resulting from the drilling operation.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be had to the accompanying drawings and descriptive matter in which there is illustrated the preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a plan view of a drill dust collection container system constructed in accordance with the principles of the present invention.

FIG. 2 is a plan view taken along line 2-2 of FIG. 1.

FIG. 3 is a side view taken along lines 3-3 of FIG. 2.

FIG. 4 is a top view taken along lines 4-4 of FIG. 3.

FIG. 5 is an enlarged view showing a cross-section of a portion of the system taken along lines 5-5 of FIG. 4 showing the knife edge.

FIG. 6 is an enlarged view showing a portion of the system taken at circle 6 of FIG. 2.

The same reference numerals refer to the same parts throughout the various Figures.

### DESCRIPTION OF THE PREFERRED EMBODIMENT

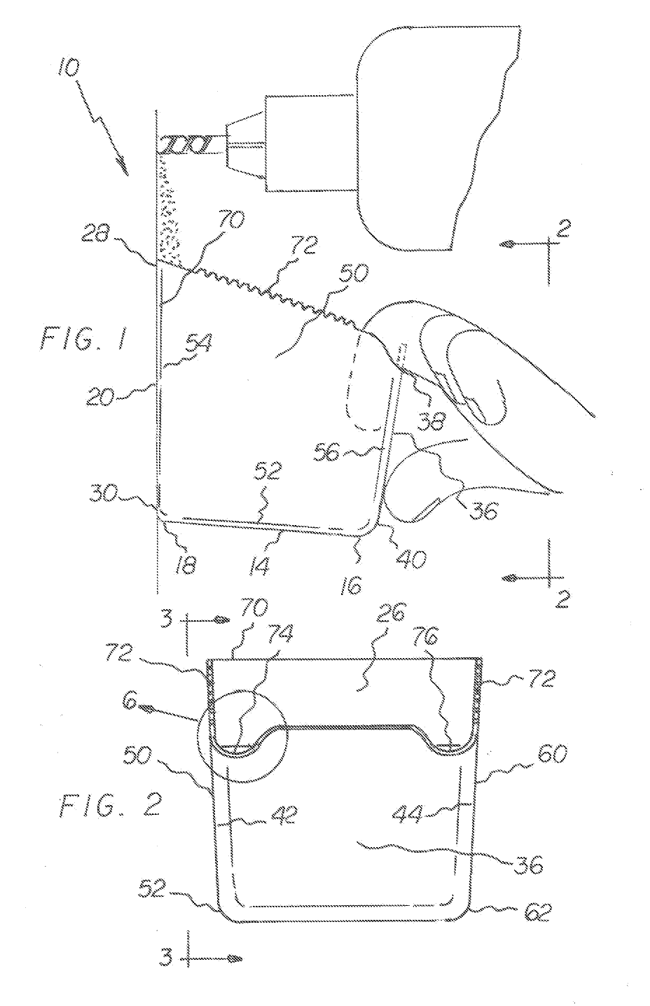

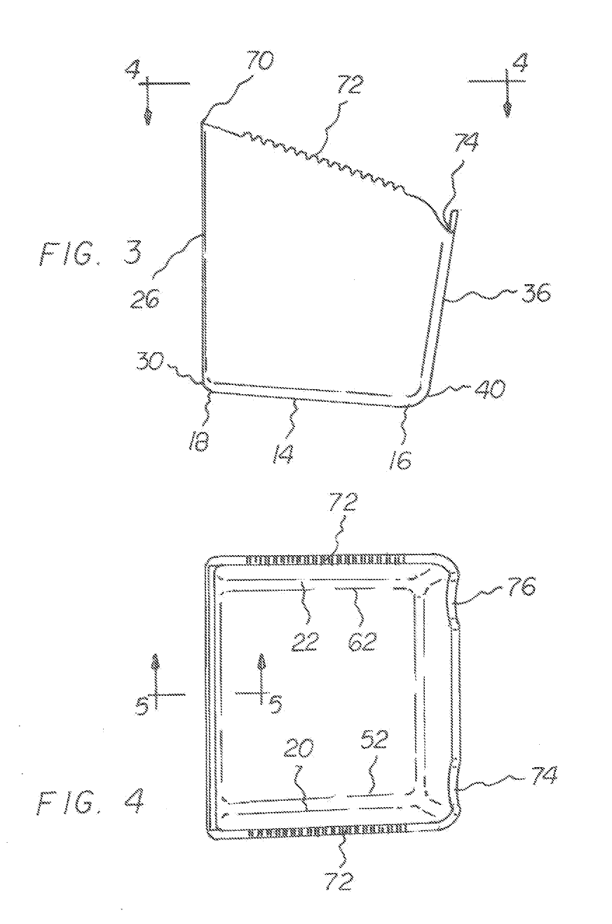

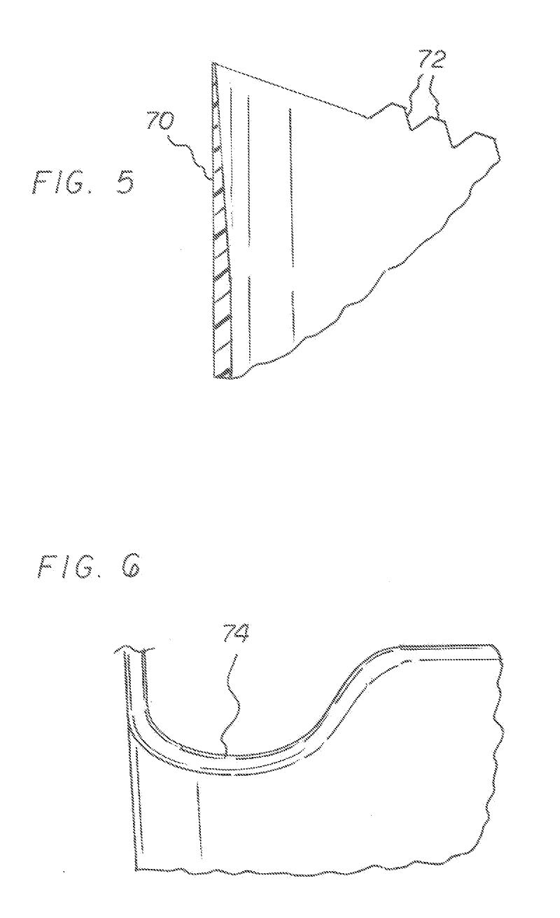

With reference now to the drawings, and in particular to FIGS. 1 through 6 thereof, the preferred embodiment of the new and improved Drill Dust Collection Container System embodying the principles and concepts of the present invention and generally designated by the reference numeral 10 will be described.

The present invention, the Drill Dust Collection Container System 10 is comprised of a plurality of components. Such components in their broadest context include a rectangular container having lower face, a rear face, a front face, a left face and a right face, and an open top, the upper rear face formed with a knife edge. Such components are individually configured and correlated with respect to each other so as to attain the desired objective.

In the broadest sense the system is comprised of a container system formed in a rectangular configuration having an open top, a lower face forming a closed bottom, a right side, a left side, a front face and a rear face. The rear face is formed with a knife edge. Serrations are formed along the upper edge of the right side and the left side. The front face is shorter than the rear face and the upper edges of the right side and left side are sloped. Dual cutouts are formed in the upper right and left corners of the front face. The container may be taped to the wall along the knife edge or held by hand using the dual cutouts as finger holds and pressing the rear face of the container against the wall.

In the preferred embodiment of the Drill Dust Collection Container System first provided is a container formed with a lower face, a rear face, a front face, a right face and a left face, the lower face 14 is formed in a square configuration with a lower forward edge 16 and a lower rearward edge 18, a first lateral edge 20 and a second lateral edge 22. All of the edges of the lower face have a length of 2.511 inches, plus or minus 20 percent.

The rear face 26 is formed in a rectangular configuration. The rear face has a rear upper edge 28 and a rear lower edge 30 separated by a height of 2.971 inches, plus or minus 20 percent. The rear face has a rear left edge and a rear right edge separated by a width of 2.511 inches, plus or minus 20 percent. The lower rearward edge 18 is coupled to the rear lower edge 30 at an angle of 94.8 degrees.

The front face 36 is formed in a rectangular configuration. The front face has a front upper edge 38 and a front lower edge 40 separated by a height of 2.217 inches, plus or minus 20 percent. The front face has a front left edge 42 and a front right edge 44 separated by a width of 2.511 inches, plus or minus 20 percent. The lower forward edge 16 is coupled to the front lower edge 40.

The left face 50 is formed in a generally quadrangular configuration. The left face has a left lower edge 52 coupled to the first lateral edge 20 of the lower face. The left face has a left rearward edge coupled to the rear left edge of the rear face 26. The left face having a left forward edge 56 is coupled to the front left edge of the front face 36.

The right face 60 is formed in a generally quadrangular configuration. The right face has a right lower edge 62 coupled to the second lateral edge 22 of the lower face. The right face has a right rearward edge coupled to the rear right edge of the rear face 26. The right face has a right forward edge coupled to the front right edge of the front face 36. The faces are fabricated of polypropylene with a thickness of 0.060 inches, plus or minus 20 percent.

A knife edge 70 is formed in the rear upper edge of the rear plate. The decreasing width of the knife edge limits obstruction of the debris falling into the container and allows for securing the system to a wall beneath a drilling operation with adhesive tape.

Serrations 72 are formed in the upper edge of the left face and in the upper edge of the right face for better gripping by a user. The serrations extend along 50 percent to 90 percent of the upper edges of the left and right faces.

A left semi-circular cut-out 74 is formed in the upper edge of the front face adjacent to the left face and a right semi-circular cut-out 76 is formed in the upper edge of the front face adjacent to the right face. Each semi-circular cut-out has a diameter equal to from 20 percent and 40 percent of the width of the front face.

The “drilling Dust Cup” is designed to catch/collect the dust and debris that results from using a power drill to drill a hole, typically in a wall. It can be handheld or taped to the surface below the target. The rear side beveled edge guides dust inwards. The serrated edges and front corner cutouts improve grip and allow for left or right hand use. Micro grooves on the outside assist gripping. The front side is lower than the back side to improve visibility. An optional feature of the cup includes a small tap located in one corner inside the cup to hold a loose drill bit.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A container system comprising:
a rectangular lower face having a lower forward edge and a lower rearward edge and a first lateral edge and a second lateral edge;
a rectangular rear face having a rear upper edge and a rear lower edge separated by a first height, the rear face having a rear left edge and a rear right edge, the lower rearward edge being coupled to the rear lower edge;
a rectangular front face having a front upper edge and a front lower edge separated by a second height, less than the first height, the front face having a front left edge and a front right edge separated by a width, the lower forward edge being coupled to the front lower edge;
a left face having a left lower edge coupled to the first lateral edge of the lower face, the left face having a left rearward edge coupled to the rear left edge of the rear face, the left face having a left forward edge coupled to the front left edge of the front face; a right face having a right lower edge coupled to the second lateral edge of the lower face, the right face having a right rearward edge coupled to the rear right edge of the rear face, the right face having a right forward edge coupled to the front right edge of the front face.

2. The system as set forth in claim 1 and further including:
a knife edge formed in the rear upper edge of the rear plate for securing the system to a wall beneath a drilling operation with adhesive tape.

3. The system as set forth in claim 1 wherein the faces are all fabricated of polypropylene with a thickness of 0.060 inches, plus or minus 20 percent.

4. The system as set forth in claim 1 and further including:
serrations formed in the upper edge of the left face and in the upper edge of the right face for better gripping by a user, the serrations extending for from 50 percent to 90 percent of the upper edges of the left and right faces.

5. The system as set forth in claim 1 and further including:
a left semi-circular cut-out formed in the upper edge of the front face adjacent to the left face, a right semi-circular cut-out formed in the upper edge of the front face adjacent to the right face.

6. The system as set forth in claim 1 and further including a small tap formed in one of the inside corners and adapted to receive a drill bit.

7. A container system for positioning beneath a drilling operation and for collecting debris from the drilling operation, the system comprising, in combination:
a lower face in a square configuration, the lower face having a lower forward edge and a lower rearward edge and a first lateral edge and a second lateral edge, all the edges of the lower face having a length of 2.511 inches, plus or minus 20 percent;
a rear face in a rectangular configuration, the rear face having a rear upper edge and a rear lower edge separated by a height of 2.971 inches, plus or minus 20 percent, the rear face having a rear left edge and a rear right edge separated by a width of 2.511 inches, plus or minus 20 percent, the lower rearward edge being coupled to the rear lower edge at an angle of 94.8 degrees;
a front face in a rectangular configuration, the front face having a front upper edge and a front lower edge separated by a height of 2.217 inches, plus or minus 20 percent, the front face having a front left edge and a front right edge separated by a width of 2.511 inches, plus or minus 20 percent, the lower forward edge being coupled to the front lower edge;
a left face in a generally quadrangular configuration, the left face having a left lower edge coupled to the first lateral edge of the lower face, the left face having a left rearward edge coupled to the rear left edge of the rear face, the left face having a left forward edge coupled to the front left edge of the front face; a right face in a generally quadrangular configuration, the right face having a right lower edge coupled to the first lateral edge of the lower face, the right face having a right rearward edge coupled to the rear right edge of the rear face, the right face having a right forward edge coupled to the front right edge of the front face, the faces all being fabricated of polypropylene with a thickness of 0.060 inches, plus or minus 20 percent;
a knife edge formed in the rear upper edge of the rear plate for securing the system to a wall beneath a drilling operation with adhesive tape;
serrations formed in the upper edge of the left face and in the upper edge of the right face for better gripping by a user, the serrations extending for from 50 percent to 90 percent of the upper edges of the left and right faces; and
a left semi-circular cut-out formed in the upper edge of the front face adjacent to the left face, a right semi-circular cut-out formed in the upper edge of the front face adjacent to the right face, each semi-circular cut-out having a diameter equal to from 20 percent to 40 percent of the width of the front face.
